(19) United States
(12) Patent Application Publication
(10) Pub. No.: US 2020/0025461 A1
(43) Pub. Date: Jan. 23, 2020

(54) METHOD OF MANUFACTURING HEAT DISSIPATION UNIT

(71) Applicant: ASIA VITAL COMPONENTS CO., LTD., New Taipei City (TW)

(72) Inventor: Chih-Yeh Lin, New Taipei City (TW)

(21) Appl. No.: 16/041,835

(22) Filed: Jul. 22, 2018

(51) Int. Cl. F28D 15/02; F28D 15/04; B23K 26/24; B23K 26/12

(52) U.S. Cl. CPC F28D 15/0283; F28D 15/046; B23K 2101/14; B23K 26/1224; B23K 26/24

(57) ABSTRACT

A heat dissipation unit manufacturing method is disclosed. The heat dissipation unit has a main body formed of a first and a second metal plate member, which together define a sealed chamber between them. The chamber has a wick structure and a working fluid provided therein, and a lip portion formed along an outer peripheral edge thereof. The lip portion includes a sinter-welded section perpendicularly connects the first metal plate member to the second metal plate member. In the heat dissipation unit manufacturing method, the first and the second metal plate member are joined along their peripheral edges by lap joint laser welding, in which a laser beam directly perpendicularly passes through the first metal plate member into one third to two thirds of a thickness of the second metal plate member, so that the two metal plate members are more firmly joined to create upgraded vacuum-tightness between them.

### FIELD OF THE INVENTION

The present invention relates to a method of manufacturing heat dissipation unit, and more particularly, to a manufacturing method for forming a heat dissipation unit having two metal plate members more firmly joined by lap joint laser welding to ensure upgraded vacuum-tightness of the heat dissipation unit.

### BACKGROUND OF THE INVENTION

Vapor chambers or flat heat pipes are widely used as heat conducting elements, and they are characterized by their high thermal conductivity. A vacuum-tight chamber formed in the vapor chamber or the flat heat pipe is filled with a working fluid, which converts between a vapor phase and a liquid phase in the vacuum-tight chamber to enable rapid thermal conduction of the vapor chamber or the flat heat pipe. The vapor chamber and the flat heat pipe are respectively formed of at least an upper and a lower metal plate member that are superposed, and a joint between the two metal plate members is sealed to form a closed chamber in between them. Then, the closed chamber is vacuumized and filled with the working fluid. The metal plate members for forming the vapor chamber and the flat heat pipe are most frequently made of copper, aluminum and stainless steel. Among others, copper is the most often used metal material because of its high thermal conductivity.

In most cases, the joint sealing of the vapor chamber and the flat heat pipe is performed by diffusion bonding, brazing or spot welding. Diffusion bonding and brazing are suitable for joining two metal plate members of the same material and can be applied to many types of metal materials. However, diffusion bonding is not suitable for joining two different types of metal materials, such as copper and aluminum or copper and stainless steel.

Spot welding can be advantageously continuously performed but it could not achieve the purpose of complete joint sealing. In the event the joint sealing of the vapor chamber is performed using spot welding, it is possibly difficult to maintain a required vacuum degree in the sealed chamber and the working fluid tends to leak due to poor air-tightness of the sealed chamber. In this case, the vapor chamber will lose its heat conducting effect.

There are vapor chamber manufacturers who join two metal plate members of dissimilar materials by lap joint laser welding. Please refer to FIGS. 1 and 1a. The currently available vapor chamber or flat heat pipe that is manufactured by the lap joint laser welding process usually includes an upper metal plate member 3a having a smaller surface area and a lower metal plate member 3b having a larger surface area. The upper and the lower metal plate member 3a, 3b are superposed with their peripheral edges overlapped with each other. The lap joint laser welding is performed at a right-angled corner formed between the overlapped peripheral edges of the upper and lower metal plate members 3a, 3b, as can be seen in FIG. 1a. While the lap joint laser welding can be used to weld two differently sized upper and lower metal plate members 3a, 3b together, there are disadvantages in the conventional way of laser welding and the laser welded joint between the materials. For instance, to form the right-angled corner between the overlapped peripheral edges of the upper and lower metal plate members 3a, 3b for performing the lap joint laser welding, the upper metal plate member 3a selected for use must be smaller than the lower metal plate member 3b in size, and the upper and the lower metal plate member 3a, 3b must be precisely aligned before the lap joint laser welding can be performed. Sometimes, a special jig is required to complete the alignment of the two metal plate members with each other.

Further, when a rounded corner appears in the path of laser welding, the initially straight welding path must be gradually changed to the curved path by welding multiple short straight lines to make up the curved path. When doing this, some areas will be repeatedly welded or the welding time will increase to adversely result in overly molten metal materials, or even damaged wick structure in the vapor chamber or the flat heat pipe, or a shrunk chamber formed in the vapor chamber or the flat heat pipe. Moreover, to form the weldable right-angled corner, the upper and the lower metal plate member 3a, 3b selected for use must be different in size, which will inevitably produce a useless lip portion around the vapor chamber of the flat heat pipe and cause unnecessary waste of metal materials.

In summary, the prior art vapor chamber and flat heat pipe forming methods have the following shortcomings: (1) wasting a lot of materials; (2) failing to provide good sealing effect; (3) requiring additional alignment of materials with each other; and (4) having difficulty in joining two dissimilar materials together.

### SUMMARY OF THE INVENTION

To overcome the above shortcomings, a primary object of the present invention is to provide a heat dissipation unit that has two metal plate members more firmly joined together.

Another object of the present invention is to provide a method of manufacturing a heat dissipation unit that has two metal plate members more firmly joined together by lap joint laser welding.

To achieve the above and other objects, the heat dissipation unit according to the present invention includes a main body.

The main body includes a first metal plate member and a second metal plate member, which together define between them a sealed chamber. At least one wick structure is provided on an inner surface of the sealed chamber; a working fluid is filled in the sealed chamber; and a lip portion is formed along an outer peripheral area of the sealed chamber. The lip portion includes a sinter-welded section that perpendicularly connects the first metal plate member to the second metal plate member.

To achieve the above and other objects, the method of manufacturing heat dissipation unit according to the present invention includes the following steps:

providing a first metal plate member and a second metal plate member;

forming a wick structure on one side of any one of the first and the second metal plate member;

correspondingly superposing the first metal plate member on the second metal plate member, and performing a lap joint laser welding operation perpendicularly to an overlapped peripheral area of the first and the second metal plate member to complete an edge sealing operation while leaving a fluid adding and vacuumizing opening on the sealed edge at a predetermined location; and

performing a vacuumizing and fluid adding operation in between the edge-sealed first and second metal plate members, and finally, sealing the fluid adding and vacuumizing opening by laser welding.

The present invention is characterized by changing the angle and the manner of laser welding the first and the second metal plate member together, so as to improve the conventional laser welding of vapor chamber and flat heat pipe that could not provide firmly joined first and second metal plate members to ensure good vacuum-tightness of the vapor chamber and the flat heat pipe.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIGS. 1 and 1a are perspective and fragmentary sectional views, respectively, of a conventional vapor chamber;

FIG. 2 is an exploded perspective view of a first embodiment of a heat dissipation unit according to the present invention;

FIG. 3 is an assembled sectional view of the heat dissipation unit of FIG. 2;

FIG. 4 is an exploded perspective view of a second embodiment of the heat dissipation unit according to the present invention;

FIG. 5 is a flowchart showing the steps included in a first embodiment of a heat dissipation unit manufacturing method according to the present invention;

FIGS. 6 and 7 are pictorial descriptions of the heat dissipation unit manufacturing method of FIG. 5;

FIG. 8 is a flowchart showing the steps included in a second embodiment of the heat dissipation unit manufacturing method according to the present invention; and

FIG. 9 is a flowchart showing the steps included in a third embodiment of the heat dissipation unit manufacturing method according to the present invention.

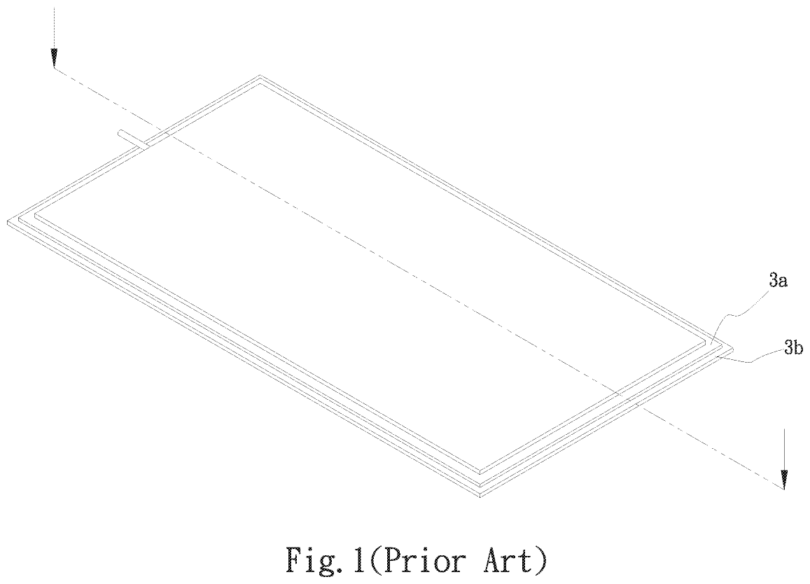

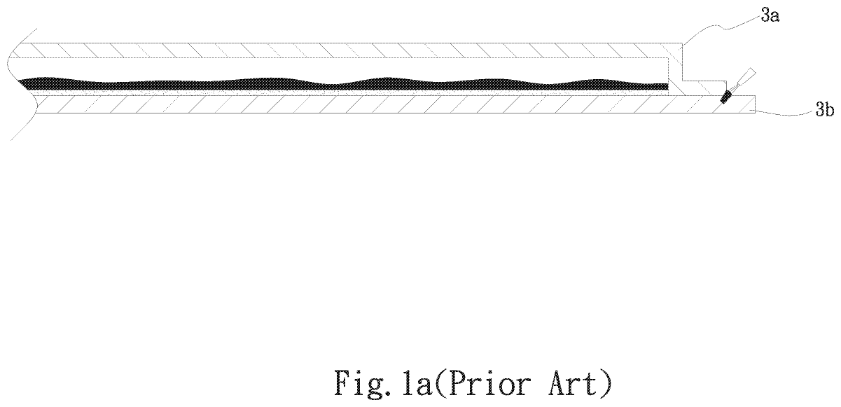

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

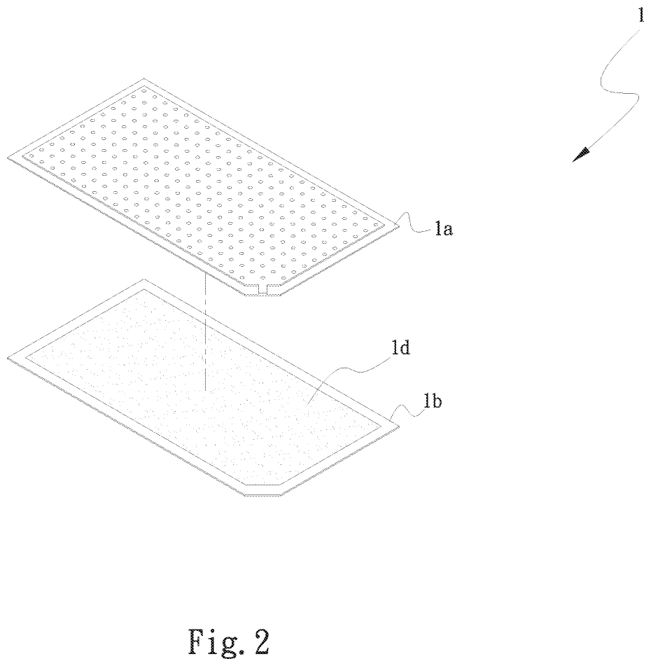

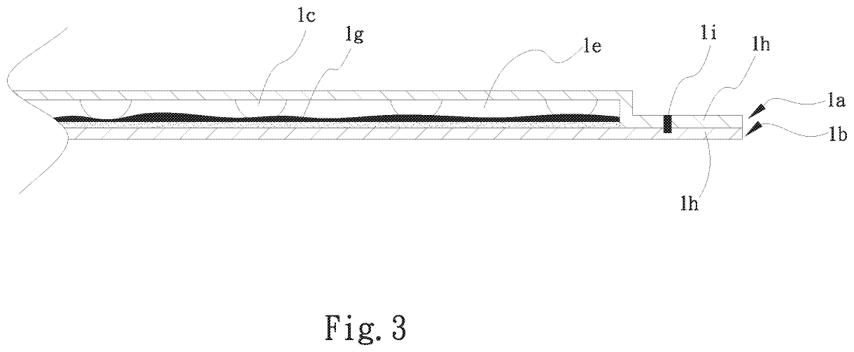

Please refer to FIGS. 2 and 3, which are exploded perspective and assembled sectional views, respectively, of a first embodiment of a heat dissipation unit according to the present invention. As shown, the heat dissipation unit in the first embodiment thereof includes a main body 1.

The main body 1 includes a first metal plate member 1a and a second metal plate member 1b, which can be respectively made of gold, silver, iron, copper, aluminum, commercially pure titanium, stainless steel or any other metal with good thermal conductivity. The first and the second metal plate member 1a, 1b together define between them a sealed chamber 1e. At least one wick structure 1d, which can be a powder-sintered structure, a fibrous structure, a mesh-like structure, or a plurality of grooves, is provided on an inner surface of the sealed chamber 1e. More specifically, the wick structure 1d can be selectively provided on an inner surface of any one of the first and the second metal plate member 1a, 1b. Further, a working fluid 1g is filled in the sealed chamber 1e. The main body 1 is formed along an outer peripheral edge of the sealed chamber 1e with a lip portion 1h, which includes a sinter-welded section 1i. The sinter-welded section 1i perpendicularly connects the first metal plate member 1a to the second metal plate member 1b by perpendicularly extending through the full thickness of the first metal plate member 1a into one third to two thirds of the thickness of the second metal plate member 1b.

The main body 1 can also include an internal supporting structure 1c, which can be formed by an external deforming force, a machining process, or additional elements. When forming the internal supporting structure 1c by an external deforming force, an external force is applied to one side of any one of the first and the second metal plate member 1a, 1b, so that areas sunken toward the other metal plate member 1a or 1b are formed to serve as the internal supporting structure 1c. When forming the internal supporting structure 1c by a machining process, the machining process, such as milling, is performed on one side of any one of the first and the second metal plate member 1a, 1b, so that protruded areas are formed to press against the other metal plate member 1a or 1b to serve as the internal supporting structure 1c. When forming the internal supporting structure 1c by additional elements, a plurality of supporting elements such as supporting posts can be provided between the first and the second metal plate member 1a, 1b to serve as the internal supporting structure 1c. However, it is understood the above-mentioned ways of forming the internal supporting structure 1c are only illustrated and not intended to limit the present invention in any way.

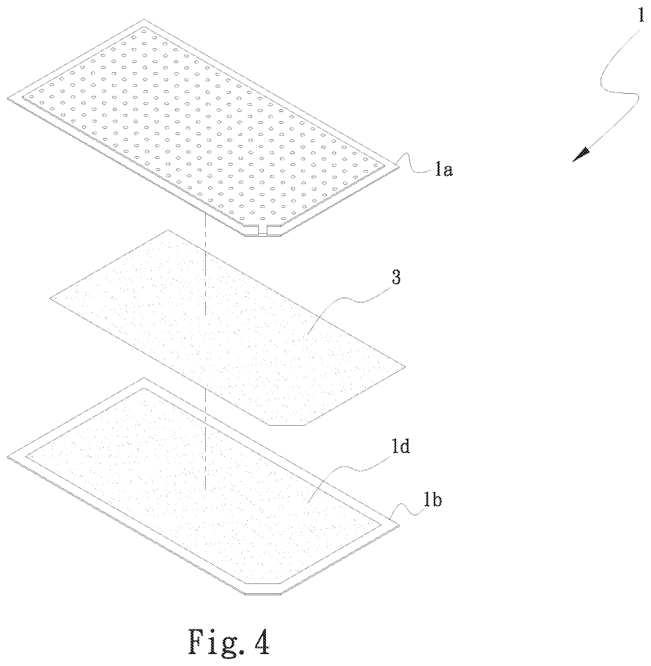

Please refer to FIG. 4, which is an exploded perspective view of a second embodiment of the heat dissipation unit according to the present invention. As shown, the second embodiment is generally structurally similar to the first one but further includes a wick member 3 disposed between the first and the second metal plate member 1a, 1b. Since all other components of the second embodiment are the same as those in the first embodiment, they are not repeatedly described in detail herein. In the second embodiment, the wick member 3 is a single piece of structural member, and can be in the form of a powder-sintered plate, a fibrous member, a mesh-like member, a corrugated plate, or a plate with a plurality of grooves. The wick member 3 can provide an auxiliary capillary force to enhance the vapor-liquid circulation efficiency of the heat dissipation unit.

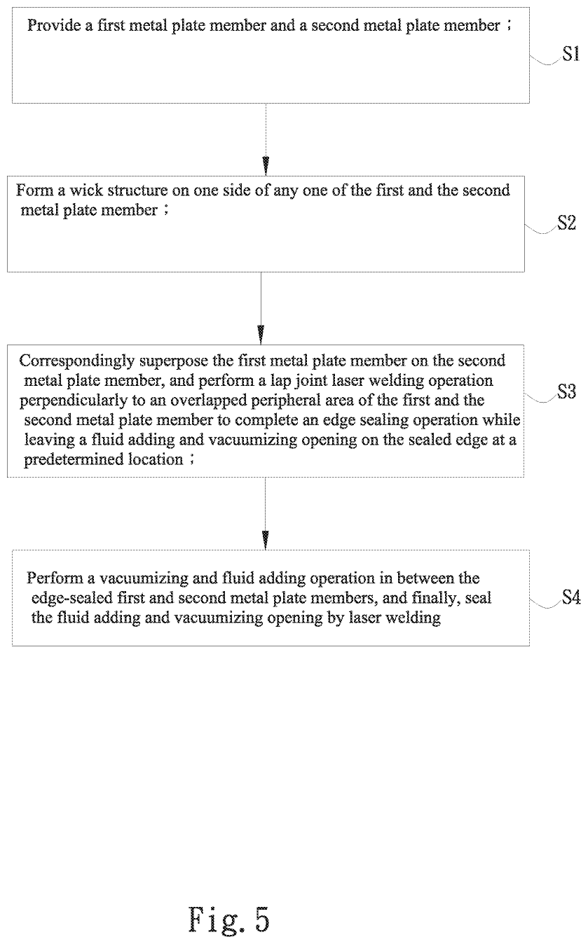

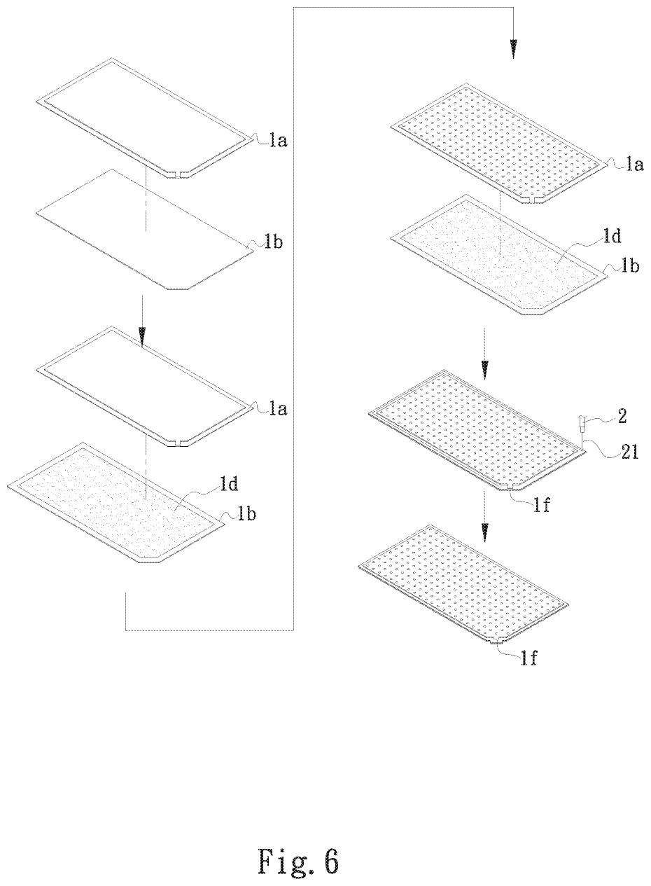

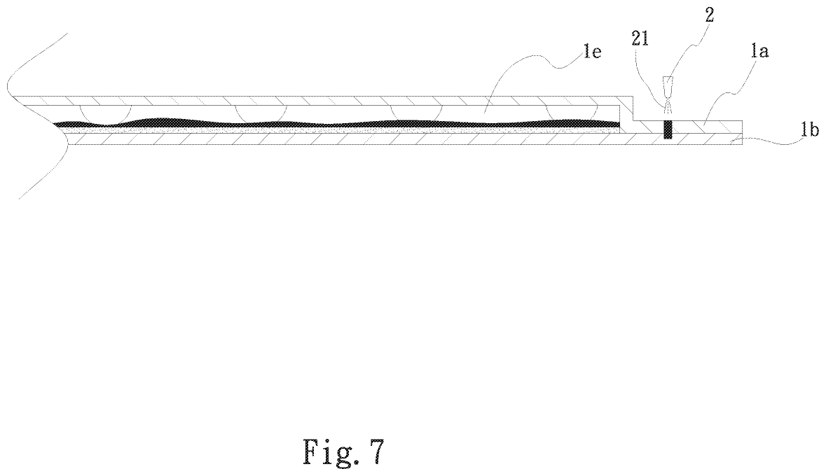

FIG. 5 is a flowchart showing four steps S1, S2, S3 and S4 included in a first embodiment of a heat dissipation unit manufacturing method according to the present invention; and FIGS. 6 and 7 are pictorial descriptions of the heat dissipation unit manufacturing method of FIG. 5. Please refer to FIG. 5 along with FIGS. 6 and 7.

In the step S1, a first metal plate member and a second metal plate member are provided.

More specifically, a first metal plate member 1a and a second metal plate member 1b are provided, which can be the same or different in size and can be respectively made of gold, silver, iron, copper, aluminum, stainless steel, a titanium alloy or commercially pure titanium. In the illustrated first embodiment, the first and the second metal plate member 1a, 1b are made of commercially pure titanium and copper, respectively. However, it is understood, in other embodiments, the first and the second metal plate member 1a, 1b can be made of other metal materials.

In the step S2, a wick structure is formed on one side of any one of the first and the second metal plate member.

More specifically, a wick structure 1d is formed on one side of any one of the first and the second metal plate member 1a, 1b or on each of two facing sides of the first and the second metal plate member 1a, 1b. The wick structure 1d can be any one of a powder-sintered structure, a mesh-like structure, a plurality of grooves, or a fibrous structure.

In the step S3, the first metal plate member is correspondingly superposed on the second metal plate member, and a lap joint laser welding is performed perpendicularly to an overlapped peripheral area of the first and the second metal plate member to complete an edge sealing operation while a fluid adding and vacuumizing opening is left on the sealed edge at a predetermined location.

More specifically, the first and the second metal plate member 1a, 1b are correspondingly superposed for forming a sealed chamber 1e between them by performing a lap joint laser welding along an overlapped peripheral area of the two metal plate members 1a, 1b. The lap joint laser welding is performed using a laser welding machine 2. During the laser welding, a laser head of the laser welding machine 2 is positioned perpendicular to the first and the second metal plate member 1a, 1b, and a laser beam 21 exited from the laser head has a wavelength range of 400 nm to 1100 nm. The laser beam 21 from the laser welding machine 2 directly perpendicularly passes through the full thickness of the first metal plate member 1a, which is located above the second metal plate member 1b, into one third to two thirds of the full thickness of the second metal plate member 1b, which is located below the first metal plate member 1a. Finally, the entire overlapped peripheral area is sealed to leave only a fluid adding and vacuumizing opening if at a predetermined location. When performing the lap joint laser welding, argon gas is preferably supplied to the area surrounding the laser head of the laser welding machine 2 as a protection inert gas to avoid the occurrence of oxidation reaction during the laser welding operation. Alternatively, the laser welding operation can be performed in a vacuum environment to protect the heat dissipation unit being welded against contamination or avoid the occurrence of oxidation reaction.

In the step S4, the sealed chamber between the first and the second metal plate member is subjected to a vacuumizing and fluid adding operation, and finally, the fluid adding and vacuumizing opening is sealed by laser welding.

More specifically, after the edge sealing operation in the step S3 is completed, a vacuumizing and fluid adding operation is performed, in which the sealed chamber between the first and the second metal plate member 1a, 1b is vacuumized to remove any gas therefrom and a working fluid is then filled into the vacuumized chamber. Finally, the previously left fluid adding and vacuumizing opening is similarly sealed by laser welding.

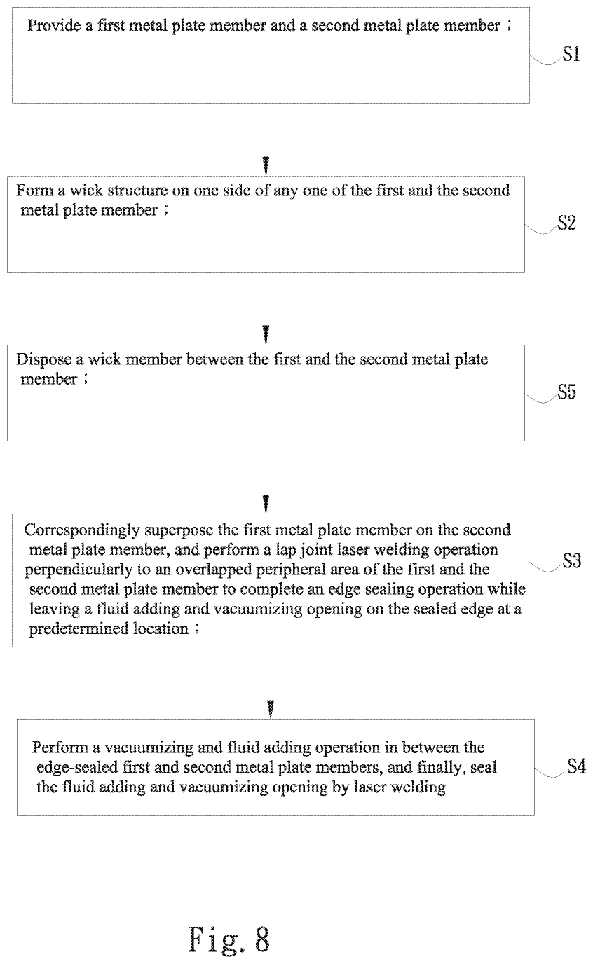

Please refer to FIG. 8 that is a flowchart showing the steps included in a second embodiment of the heat dissipation unit manufacturing method according to the present invention. As shown, the method of the present invention in the second embodiment thereof is different from the first one in further including a step S5 after the step S2 of forming a wick structure on one side of any one of the first and the second metal plate member. In the step S5, a wick member is disposed between the first and the second metal plate member. More specifically, a wick member 3 in the form of a single-piece structural member is disposed between the first and the second metal plate member 1a, 1b; and the wick member 3 can be a powder-sintered plate, a fibrous member, a mesh-like member, a corrugated plate, or a plate with a plurality of grooves.

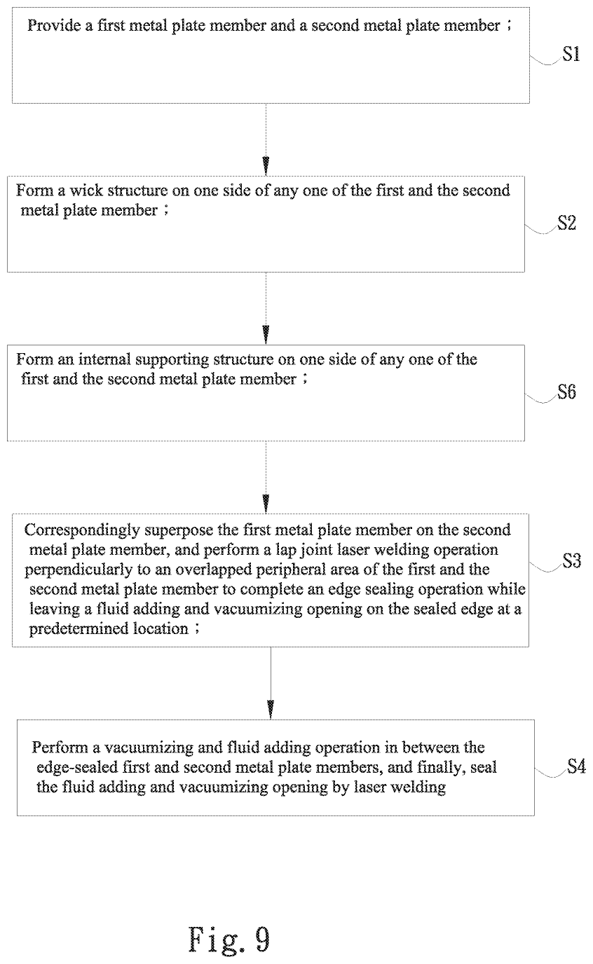

Please refer to FIG. 9 that is a flowchart showing the steps included in a third embodiment of the heat dissipation unit manufacturing method according to the present invention. As shown, the method of the present invention in the third embodiment thereof is different from the first one in further including a step S6 after the step S2 of forming a wick structure on one side of any one of the first and the second metal plate member. In the step S6, an internal supporting structure is formed on one side of any one of the first and the second metal plate member.

More specifically, an internal supporting structure 1c is formed on or between the first and the second metal plate member 1a, 1b by an external deforming force, a machining process, or additional elements. When forming the internal supporting structure 1c by an external deforming force, an external force is applied to one side of any one of the first and the second metal plate member 1a, 1b, so that areas sunken toward the other metal plate member 1a or 1b are formed to serve as the internal supporting structure 1c. When forming the internal supporting structure 1c by a machining process, the machining process, such as milling, is performed on one side of any one of the first and the second metal plate member 1a, 1b, so that protruded areas are formed to press against the other metal plate member 1a or 1b to serve as the internal supporting structure 1c. When forming the internal supporting structure by additional elements, a plurality of supporting elements such as supporting posts can be provided between the first and the second metal plate member 1a, 1b to serve as the internal supporting structure 1c. While the third embodiment of the method of the present invention is described with an internal supporting structure formed by an external deforming force, it is understood the use of an external deforming force to form the internal supporting structure is only illustrated and not intended to limit the present invention in any way.

The present invention is characterized in that lap joint laser welding is used to overcome the disadvantages of using general laser welding to weld metal plate members made of commercially pure titanium, titanium, or copper; and that the laser head of the laser welding machine 2 used in the lap joint laser welding is positioned perpendicularly to the lip portion 1h of the first and second metal plate members 1a, 1b; and that the laser beam 21 exited from the laser head directly perpendicularly passes through the full thickness of the first metal plate member 1a into one third to two thirds of the full thickness of the second metal plate member 1b to complete the joining of the two metal plate members 1a, 1b. In this manner, unlike the conventional vapor chamber or flat heat pipe, an upgraded joint and vacuum-tightness between the first and the second metal plate member 1a, 1b of the heat dissipation unit of the present invention can be achieved using lap joint laser welding while the two metal plate members 1a, 1b can be easily aligned with each other for welding.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of manufacturing heat dissipation unit, comprising the following steps:
providing a first metal plate member and a second metal plate member;
forming a wick structure on one side of any one of the first and the second metal plate member;
correspondingly superposing the first metal plate member on the second metal plate member, and performing a lap joint laser welding operation perpendicularly to an overlapped peripheral area of the first and the second metal plate member to complete an edge sealing operation while leaving a fluid adding and vacuumizing opening on the sealed edge at a predetermined location; and
performing a vacuumizing and fluid adding operation in between the edge-sealed first and second metal plate members, and finally, sealing the fluid adding and vacuumizing opening by laser welding.

2. The method of manufacturing heat dissipation unit as claimed in claim 1, wherein the first and the second metal plate member are respectively made of a material selected from the group consisting of gold, silver, iron, copper, aluminum, commercially pure titanium, a titanium alloy, and stainless steel.

3. The method of manufacturing heat dissipation unit as claimed in claim 1, wherein the lap joint laser welding operation is performed while an amount of inert gas, such as argon gas, is supplied to an area surrounding the welding operation to avoid occurrence of oxidation reaction.

4. The method of manufacturing heat dissipation unit as claimed in claim 1, wherein the lap joint laser welding operation is performed in a vacuum environment.

5. The method of manufacturing heat dissipation unit as claimed in claim 1, wherein the first and the second metal plate member can be similar or different in size.

6. The method of manufacturing heat dissipation unit as claimed in claim 1, wherein the lap joint laser welding operation is so performed that a laser beam passes through a full thickness of the first metal plate member into one third to two thirds of a full thickness of the second metal plate member.

7. The method of manufacturing heat dissipation unit as claimed in claim 1, wherein the lap joint laser welding operation is performed with a laser beam having a wavelength range of 400 nm to 1100 nm.

8. The method of manufacturing heat dissipation unit as claimed in claim 1, further comprising a step after the wick structure forming step to dispose a wick member between the first and the second metal plate member; and the wick member being selected from the group consisting of a powder-sintered plate, a mesh-like member, and a fibrous member.

9. The method of manufacturing heat dissipation unit as claimed in claim 1, further comprising a step after the wick structure forming step to form an internal supporting structure on one side of any one of the first and the second metal plate member.

10. The method of manufacturing heat dissipation unit as claimed in claim 9, wherein the internal supporting structure is selectively formed by one of an external deforming force, a machining process and additional elements; wherein in the case of forming the internal supporting structure by an external deforming force, an external force is applied to one side of any one of the first and the second metal plate member, so that areas sunken toward the other metal plate member are formed to serve as the internal supporting structure; wherein in the case of forming the internal supporting structure by a machining process, the machining process is performed on one side of any one of the first and the second metal plate member, so that protruded areas are formed to press against the other metal plate member to serve as the internal supporting structure; and wherein in the case of forming the internal supporting structure by additional elements, a plurality of supporting elements such as supporting posts can be provided between the first and the second metal plate member to serve as the internal supporting structure.
